(19) United States
(12) Patent Application Publication
(10) Pub. No.: US 2021/0363024 A1
(43) Pub. Date: Nov. 25, 2021

(54) METHOD FOR PRODUCING POROUS COMPOSITE BODIES WITH THERMALLY CONDUCTIVE SUPPORT STRUCTURE

(71) Applicant: FRAUNHOFER-GESELLSCHAFT ZUR FOERDERUNG DER ANGEWANDTEN FORSCHUNG E.V., Muenchen (DE)

(72) Inventors: JOACHIM BAUMEISTER, Bremen (DE); JÖRG WEISE, Bremen (DE); OLGA YEZERSKA, Bremen (DE); SEBASTIAN-JOHANNES ERNST, Bremen (DE)

(21) Appl. No.: 17/053,415

(22) PCT Filed: May 7, 2019
(86) PCT No.: PCT/EP2019/061696

§ 371 Date: Nov. 6, 2020

(30) Foreign Application Priority Data
May 8, 2018 (DE) 10 2018 207 143.8

(51) Int. Cl. C01B 39/24; C25D 1/08

(52) U.S. Cl. CPC C01B 39/24; B01J 20/183; C01P 2004/32; C25D 1/08

(57) ABSTRACT

In a method for producing porous composite bodies, which have a support structure made of a material having good thermal conductivity and which have at least one functional material, a multiplicity of shaped bodies (1) made of the functional material are coated with the material having good thermal conductivity and a solid connection between the coated shaped bodies (1) is established in order to form the support structure made of the material having good thermal conductivity. The coating (2) is generated with a porous structure or is provided with a porous structure, which, after the solid connection has been established, permits access for a liquid or gaseous medium through the coating to the functional material. The method permits cost-effective production of porous composite bodies with very good heat transfer properties.

### TECHNICAL FIELD OF APPLICATION

The present invention relates to a method for producing porous composite bodies which have a support structure consisting of a thermally conductive material and at least one functional material, in particular for producing sorption bodies or catalysts. The invention also relates to porous composite bodies which can be produced with the method.

Composite bodies which have a support structure with good thermal conductivity and suitable adsorbent materials as the functional material are essential, especially in the field of adsorption technology, in adsorption refrigerators or adsorption heat pumps for example. Besides other attributes, the support structure must have good thermal coupling conditions, good internal heat transfer and mechanical stability. The support structure should also have a large surface area for heat transfer processes and for fixing the functional materials, the lowest possible weight, small installation space and a low thermal mass.

### RELATED ART

DE 101 59 652 A1 describes a method for producing a porous composite body, in which a foam-like matrix is prepared from a metal foam, into which the sorption material is infiltrated as dry bulk material. Unfortunately, in such a design the thermal contact between the functional material and the thermally conductive support structure is less than ideal.

DE 197 30 697 A1 describes an adsorption heat pump in which the adsorbent is spread over the area of a heat exchanger surface as a granulate and is affixed to this heat exchanger surface with an adhesive. However, the use of an adhesive between the functional material and the thermally conductive support structure is disadvantageous because adhesives of such kind often have poor thermal conductivity. The thermal linking of the functional material to the thermally conductive surface is therefore poor.

DE 10 2008 023 481 B4 describes a method for producing thermally conductive composite adsorbents in which the functional material is integrated in a highly porous metal structure not subsequently but actually during production thereof. In such a case, in one variation an absorbent-containing melt of the thermally conductive material is foamed to form the composite body. In another variant, a mixture of the adsorbent and the thermally conductive material is introduced into a porous preform placed in readiness, with the result that after the preform is removed a sponge-like structure containing the adsorbent is obtained.

From DE 10 2005 001 056 B4, a method is known for producing a porous composite structure with functional materials, in which a dry bulk volume of the sorbent material is provided in granular form and then infiltrated with an aluminium melt as thermally conductive material.

DE 10 2006 048 445 A1 describes a method for producing a composite body for storing and recovering thermal energy. The composite body in this case consists of a thermally conductive carrier, wherein microstructures are applied or formed on the surface thereof and are covered with a functional material.

A composite material consisting of a porous polymer matrix in which zeolites are embedded as the functional material and a metal material is known from EP 2 532 421 A1. The metal material may be embedded in the form of a perforated metal plate for example, or a metal mesh, or even in particulate form.

The problem to be solved by the present invention is that of providing a method for producing porous composite bodies with a support structure from a material having good thermal conductivity and at least one functional material, which offer particularly good heat transfer properties with low material use and can be manufactured inexpensively.

### SUMMARY OF THE INVENTION

The problem is solved with the method and the porous composite body according to claims 1 and 13. Advantageous variations of the method and of the suggested composite body are the objects of the dependent claims or may be inferred from the following description and the embodiments.

In the suggested method for producing porous composite bodies which have a support structure made of a material which preferably has good thermal conductivity, in particular a metallic material, and at least one functional material, a multiplicity of shaped bodies from the functional material are provided. These shaped bodies are preferably a granulate or tubes or rods made of the functional material. These shaped bodies are then coated with the material having good thermal conductivity, and a solid connection is established between the coated shaped bodies in order to form the support structure made from the material having good thermal conductivity. With the method, the coating is either already generated with a porous structure, or it is provided with a porous structure after the coating process has been carried out, which porous structure permits access for a liquid or gaseous medium passing through the coating to the functional material after the solid connection has been established.

Unlike known methods of the prior art, in the suggested method a support structure with good thermal conductivity is thus not coated with functional materials. Instead, shaped bodies made from the functional material are coated with the material having good thermal conductivity. Consequently, the (porous) layer of the material having good thermal conductivity is located between the functional material and the surrounding atmosphere. The exchange of materials with the atmosphere, e.g., transfer of water vapour, takes place through the thermally conductive carrier layer. The suggested method makes it possible to set very large contact surfaces between the thermally conductive material and the functional material. The suggested procedure also enables more extensive design freedoms of the overall structure. Due to the coating of the shaped bodies made from the functional material with the material having good thermal conductivity, thermal contact takes place over the entire outer surface of the shaped bodies, which is also where most of the heat is generated in the corresponding processes, in particular adsorption or catalytic processes. The heat may thus be dissipated highly efficiently. Metals, carbons, carbides or thermally conductive polymers for example may be used as thermally conductive materials. The thermally conductive materials preferably have a thermal conductivity (at 0°) of at least 100 W/(m·K).

Compared with a method in which the interspaces in a dry bulk volume of a granulate of the functional material are filled with the material having good conductivity, the suggested method requires a smaller quantity of thermally conductive material for comparable heat dissipation performance. Thus, most thermally conductive material in the interspaces in a dry volume does not contribute to the thermal connection of the granulate, and its contribution to total heat transfer is—relative to mass—lower than in layers which lie close to the boundary surface with the granulate. Consequently, the suggested method makes it possible to achieve particularly good heat transfer properties of the composite body with low material investment, and as a result the composite body can also be produced inexpensively.

In an advantageous variant of the suggested method, the solid connection of the coated shaped bodies is produced by a sintering process. If the coating consisting of the material with good thermal conductivity does not yet have the requisite porous structure before the sintering process, this porous structure can be achieved by means of the sintering process. If the porous structure already exists, the porosity of the coating is at least partially preserved by the sintering process.

The coating may be carried out in such manner that the required open-pored structures already form on the surface of the shaped bodies made of the functional material as a result of the coating process. Alternatively, if a connected, closed and non-porous layer is applied or deposited, this layer must be structured and/or opened correspondingly afterwards so that the functional material becomes accessible. Opening can be carried out by heat treatment, for example also by the sintering process which is performed preferably, by removal of placeholders incorporated in the layer, mechanically or also chemically, for example by etching.

The coating of the shaped bodies with the material having good thermal conductivity may be performed for example in a deposition process. Accordingly, a deposition of a metallic material on the shaped bodies made of functional material may be effected by means of PVD (PVD: Physical Vapour Deposition) or by electrochemical or galvanic deposition, wherein a sintering process may be carried out subsequently if necessary. The galvanic deposition may also be carried out in such manner that the deposition process already gives rise to a porous but load-bearing interconnected system made of the metal material.

A further option is to produce a coating for the shaped bodies using a suitable binder. For this purpose, the shaped bodies are mixed with the binder and particles or fibres of the material having good thermal conductivity in order to coat the shaped bodies with the particles or fibres of the material having good thermal conductivity by means of the binder. In this context, both particles and fibres of the material having good thermal conductivity should have measurements which are considerably smaller than the measurements of the shaped bodies in order to be able to produce a coating of the shaped bodies. Therefore, the particles or fibres of the material having good thermal conductivity have measurements which are smaller by a factor of 10 than the smallest measurements of the shaped bodies in one, two or all three dimensions.

In a coating process of such kind in which the components involved are mixed, a mixing ratio between the functional material and the thermally conductive material is preferably chosen with which—with a porosity of the coating between 5 and vol. %—the volume fraction of the functional or active material is between 40 and 70 vol. % and the volume fraction of the thermally conductive material is between 10 and 30 vol. %. The total of the volume fractions and the porosity is always equal to 100%. For typical sizes of the active material granulate (50 micrometres-3 mm), the layer thickness of the thermally conductive material on the shaped bodies made of the functional or active material may have very different values, which may vary between 1 and 200 μm, for example.

The coating and the formation of a stable total structure may be carried out at the same time in one step, or also consecutively. Additionally, a connection can already be established with bodies or fabrics made from a heat transfer material such as a metallic tube or a metal-coated textile fabric in one of the steps of the suggested method, in particular when the solid connection is created between the coated shaped bodies.

In principle, in the suggested method different steps may be associated with each other and/or completed simultaneously. In the following text, a few examples on this theme will be explained, in which zeolite in the form of a granulate serves as the functional material and copper (Cu) is used as the thermally conductive material. The examples can be carried out in this form with other functional materials and/or other thermally conductive material as well.

Thus for example a sufficiently porous Cu layer can be generated on the zeolite granulate by direct electrochemical deposition. This porous structure is preserved in the subsequent sintering together of the coated granulates to create a total structure, which forms the composite body. Tubes or other heat transfer bodies may be pre-sintered at the same time during the same sintering process, or also connected to the composite body subsequently, by brazing for example. This also applies for the other examples.

In a further example, largely closed Cu-layers are deposited on the zeolite granulate by means of PVD. In the sintering together of the coated granulates which follows this, the layers are reshaped and form a kind of porous network.

The option also exists to apply a porous layer consisting of Cu powder onto the zeolite granulate with the aid of a binder. When the coated granulates are sintered together, the porosity of the powder layer is at least partially preserved, so that the porous composite body can also be obtained in this way.

The suggested porous shaped body which is producible with the method thus correspondingly comprises a large number of shaped bodies of the functional material coated with the material having good thermal conductivity, which are connected solidly to each other via the material having good thermal conductivity. The coating has a porous structure which permits access for a liquid or gaseous medium through the coating to the functional material.

The suggested method and the porous composite bodies produced therewith can be applied in many fields, in which efficient heat dissipation from functional materials is required. Examples are sorption heat pumps or also applications related to gas storage systems, gas separation or catalysis.

### BRIEF DESCRIPTION OF THE DRAWING

In the following section, the suggested method will be explained again in greater detail with reference to exemplary embodiments in conjunction with the drawing. In the drawing:

FIG. 1 is a schematic representation of shaped bodies which have been coated and connected solidly to each other according to the suggested method;

FIG. 2 is a representation of the zeolite as a fraction of the total structure depending on the diameter of a spherical zeolite granulate and the thickness of the coating with porosity of 20 vol. %;

FIG. 3 is a further representation of the zeolite as a fraction of the total structure depending on the diameter of a spherical zeolite granulate and the thickness of the coating with porosity of 20 vol. %

FIG. 4 is a photograph of the structure of a composite body produced with the method;

FIG. 5 is a representation of a spherical shaped body made of zeolite and coated with copper; and

FIG. 6 is a representation of a tubular shaped body made of zeolite and coated with copper fibres.

### WAYS TO IMPLEMENT THE INVENTION

In the suggested method, a thin layer with high thermal conductivity, of copper for example, is deposited on or applied to the surface of shaped bodies of a functional material such as zeolite. A porous structure of this layer is generated either immediately during the coating or in a subsequent method step. The coated shaped bodies are then connected solidly with each other to form a total structure which forms the porous composite body. This may be done by sintering for example. A connection via a binding agent that may optionally be applied during coating may also be used. The total structure is linked to peripheral elements such as tubes, housings etc., preferably subsequently or also simultaneously with the connection process.

FIG. 1 shows a highly simplified view of four coated spherical shaped bodies 1 of zeolite, which have been coated with a thin Cu-layer 2 and connected to each other via this thin layer by a sintering process. As a result, the thin Cu-layer has a sufficiently porous structure (not discernible in the figure) to allow liquid or gaseous media to gain access to the zeolite. FIG. 1 with the four shaped bodies shows only a very small detail of the total structure in diagrammatic form.

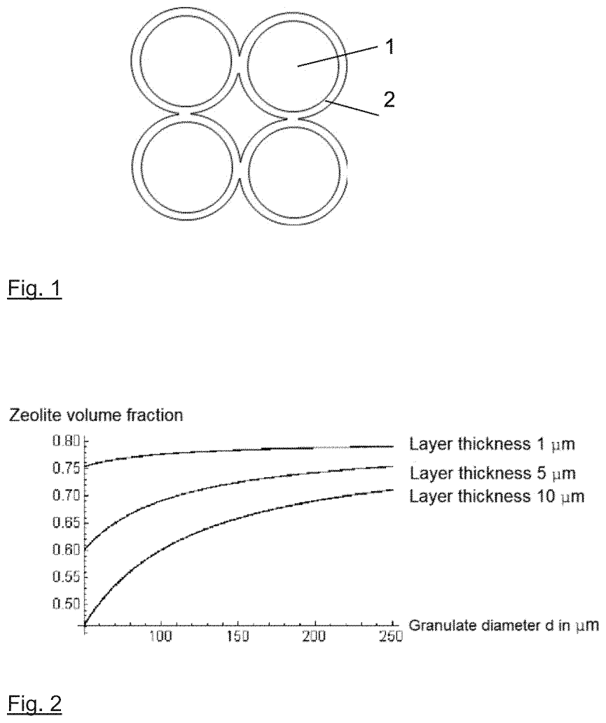

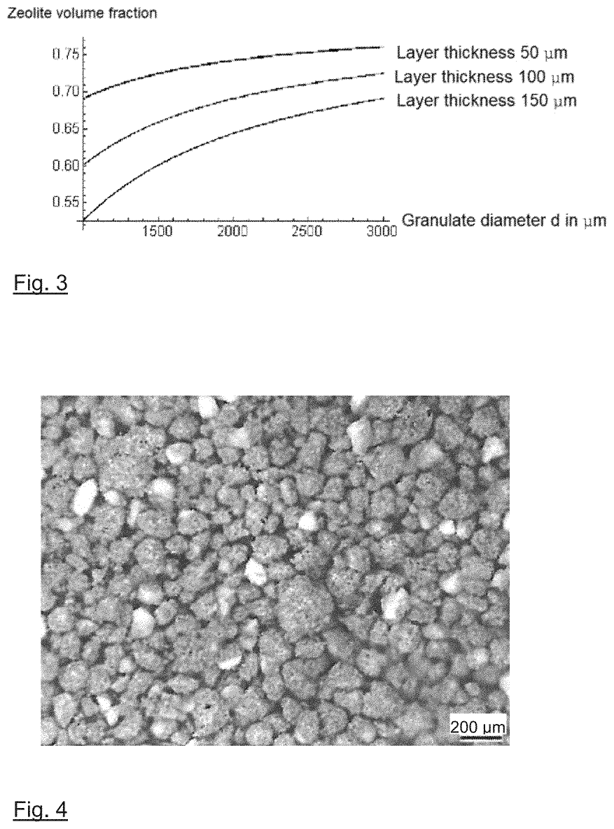

Exemplary volume ratios for the functional material in the total structure, i.e. the composite body, may be deduced from FIGS. 2 and 3, each of which shows, using the example of zeolite as the functional material, the percent of zeolite in the total structure depending on the diameter of the zeolite granulate used in this example and on the thickness of the coating. In this context, FIG. 2 shows granulate diameters between 50 and 250 μm with coating thicknesses of 1, 3 and 5 μm Cu, FIG. 3 shows granulate diameters between 1000 and 3000 μm with coating thickness of 50, 100 and 150 μm. The volume percentages of the zeolite are preferably each in the range between 0.5 and 0.75. Volume percentages of the zeolite of about 70 vol. % are particularly advantageous.

In the following section, various examples of the production of porous composite bodies with the suggested method are described. In a first example, Y-zeolite granulate with a fraction of 63-125 μm is stirred together with water and an organic binder (e.g., ExOne®). Then, Cu-UF10 powder (<10 μm) is added. The mass is stirred, introduced into a form, for example a cylinder form, and dried. This is followed by heat treatment at 420° C. for 1 h in air to burn out the binder, and a sintering in hydrogen atmosphere at 600° C. for 3 h. The result is a cylinder which is stable enough for simple handling. The zeolite still exhibits good water uptake even after sintering. The sintering conditions have not caused a degradation of the zeolite. FIG. 4 shows an photo of a structure of the cylinder for exemplary purposes. It is evident from this figure that only the surface of the zeolite granulate is covered with a porous layer of Cu particles. The stability of the overall body is established by the sintered contacts among the Cu layers.

In this example, it is also possible to economise on the heat treatment at 420° C./1 h in air, and to effect the burnoff of the binder by maintaining a temperature ramp during the sintering treatment.

If the first example is performed with round Y-zeolite granulate (granulate diameter approx. 2 to 3 mm), coarser structures are created, wherein the porous copper layer on the zeolite particles is still porous even after sintering and also exhibits shrinkage cracks which improve access to the zeolite.

In a second example, Y-zeolite granulate (fraction 63-125 μm) is mixed with water and a suitable binder. Cu-UF10 powder is added and the mass is stirred. A coppered polyamide fabric is laid out flat and the mass is painted onto the textile. This is followed by drying in air, burning out the binder and polyamide, and oxidising at 420° C. for 1 h. Finally, the structure is sintered for 3 h at 600° C. in H₂. The thin layers of copper powder ensure that Y-zeolite holds together well and connects to the fabric during the sintering. The fabric serves both to stabilise the total structure mechanically and functions as a directed, heat conducting structure (strongly directed thermal conductivity). Textiles coated in this way are very well suited for connection with cooling pipes. The coated fabric may by connected to a copper flat tube for example during sintering. The fabric is aligned towards the flat tube and accordingly transports heat away from the tube very effectively.

In a third example, Y-zeolite granulate (fraction 63-125 μm) is stirred together with water and silicone based binder (e.g., P8OX). Then, Cu-UF10 powder is added. The mass is stirred again and then dried. This is followed by an oxidation treatment at 420° C. for 1 h in air and sintering at 600° C. for 2 h in hydrogen atmosphere. Since the thermally resistant binder still has good strength even after the sintering, the mechanical resistance of the total structure is not based solely on the strength of the sinter contacts within and among the copper layers. The copper content may therefore be reduced to a level which is just sufficient to meet the thermal requirements (thermal conductivity). This in turn serves to reduce costs further.

In a fourth example, Y-zeolite granulate (fraction >400 μm) is stirred together with water and a suitable binder. In this case, the water and binder are added in small enough quantities to ensure that a cohesive slurry does not form, but instead the granulate beads are coated individually, and so remain flowable. The coated beads are then dried and can be stored for longer. Later, the coated granulate can be poured into hollow structures that are to be filled. A sintering treatment such as was described in the first example then cause the granules to bind to each other and the surrounding coating structure.

A further option for producing the porous composite body exploits material displacements during sintering processes. It is known that homogenous copper layers can be deposited on ceramic granulates, e.g., cenospheres (aluminium silicates) by using fluid bed PVD processes. With the aid of layers of this kind, the granulates can be sintered together to form solid structures. A known but hitherto neglected effect is that under certain sintering conditions the compact cupper layers are transformed into porous, flat meshes. This phenomenon is used in the present example to create the porous structure.

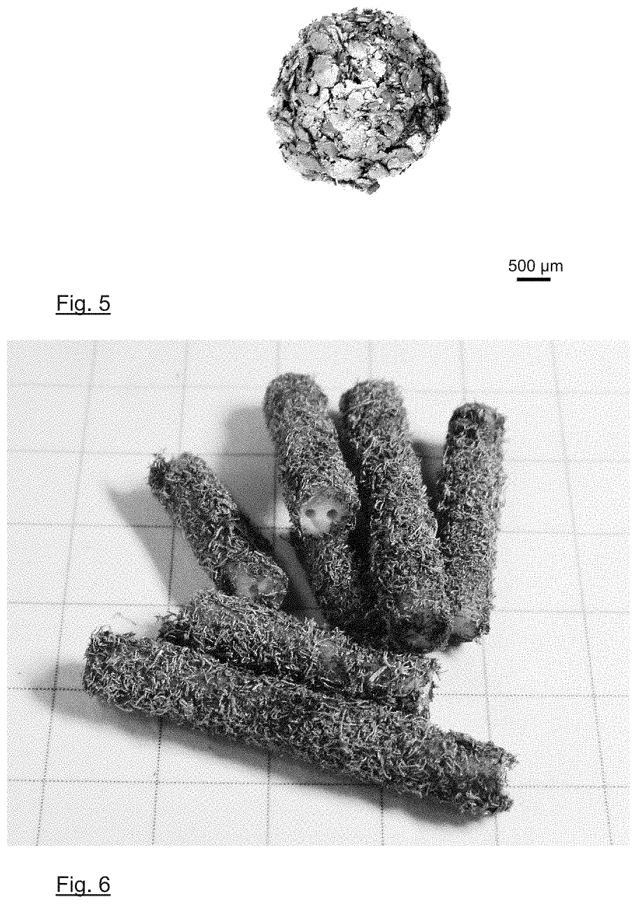

Finally, FIG. 5 shows another example of spherical shaped bodies of zeolite coated with copper particles, FIG. 6 shows an example of zeolite tubes which have been coated with copper fibres. With the suggested method, many such coated shaped bodies are produced and connected with each other to form the porous composite body. When metallic material us used as the material having good thermal conductivity, the method by means of a sintering process enables a connection to be created which is materially bonded, metallic and electrically conductive in each case to form a metal structure as a thermally conductive support structure.

1. Method for producing porous composite bodies which have a support structure made of a thermally conductive material and at least one functional material, in particular for producing sorption bodies or catalysts, in which
a multiplicity of shaped bodies is prepared from the functional material,
the shaped bodies are coated with the thermally conductive material, and
a solid connection is established between the coated shaped bodies in order to form the support structure from the thermally conductive material,
wherein the coating of the shaped bodies is generated with a porous structure or is furnished with a porous structure which after the solid connection has been established permits access for a liquid or gaseous medium through the coating to the functional material.

2. Method according to claim 1,
characterized in that
the solid connection between the coated shaped bodies is created by a sintering process.

3. Method according to claim 2,
characterized in that
the porous structure of the coating is created by the sintering process.

4. Method according to claim 1,
characterized in that
the coating of the shaped bodies is applied by a deposition process.

5. Method according to claim 4,
characterized in that
the coating of the shaped bodies is applied by PVD.

6. Method according to claim 4,
characterized in that
the coating of the shaped bodies is applied by electrochemical deposition of a porous layer of the thermally conductive material.

7. Method according to claim 1,
characterized in that
in order to coat the shaped bodies with the thermally conductive material the shaped bodies are mixed with a binder and particles or fibres of the thermally conductive material.

8. Method according to claim 7,
characterized in that
the particles or fibres of the thermally conductive material have sizes that are smaller than the measurements of the shaped bodies by a factor of 10 in at least one dimension.

9. Method according to claim 7,
characterized in that
the shaped bodies and the particles or fibres of the thermally conductive material are mixed with each other in a mixing ratio at which—with a porosity of the coating between 5 and 25 vol. %—the volume percentage of the functional material is between 40 and 70 vol. % and the volume percentage of the thermally conductive material is between 10 and 30 vol. %.

10. Method according to claim 1,
characterized in that
the functional material is supplied in the form of a granulate, in the form of rods or in the form of tubes.

11. Method according to claim 1,
characterized in that
the shaped bodies are prepared from an adsorbent material or a catalyst material as the functional material.

12. Method according to claim 1,
characterized in that
when the solid connection is established, the coated shaped bodies are also connected with a thermally conductive body, in particular a tube, a housing or a plate.

13. Porous composite body which has a support structure made of a thermally conductive material and a multiplicity of shaped bodies made of at least one functional material, which are covered by a coating of the thermally conductive material and are solidly connected to each other via the coating, wherein the coating has a porous structure which permits access for a liquid or gaseous medium through the coating to the functional medium.
